(19) United States
(12) Patent Application Publication
(10) Pub. No.: US 2016/0336857 A1
(43) Pub. Date: Nov. 17, 2016

(54) SWITCHING-MODE POWER SUPPLIES

(71) Applicant: SMART CHIP MICROELECTRONIC CO. LIMITED, Mongkok, Kowloon (CN)

(72) Inventor: Loi Ying LIU, Hong Kong (CN)

(73) Assignee: SMART CHIP MICROELECTRONIC CO. LIMITED, Mongkok, Kowloon (CN)

(21) Appl. No.: 15/113,784

(22) PCT Filed: Jan. 26, 2015
(86) PCT No.: PCT/IB2015/050556

§ 371 Date: Jul. 22, 2016

(30) Foreign Application Priority Data
Jan. 24, 2014 (CN) 14100822.8

(51) Int. Cl. H02M 3/158; H02M 1/08

(52) U.S. Cl. CPC H02M 3/158; H02M 1/08; H02M 2001/0009

(57) ABSTRACT

A switching mode power control device (100) to operate a first electronic switch (Ml) to switch a power input (VIN) by switching to vary output power is provided, wherein the device (100) is to operate the first electronic switch (Ml) such that either an ON-voltage-pulse or an OFF-voltage-pulse will appear at an output terminal (SW) of the first switch (Ml), and the device (100) is to determine and/or control current output with reference to an output voltage at said output terminal (SW) of the first electronic switch (SW).

### FIELD

The present disclosure relates to switching-mode power supplies, and more particularly to switching-mode power supplies having a power switching controller to control and regulate switching of a switchable network to regulate output power supply and apparatus comprising same.

### BACKGROUND

Switching-mode power supplies, also known as switched-mode power supplies or “SMPS”, are widely used in applications where electrical power conversion such as DC-DC conversion is required. Switching-mode power supplies are widely used as power supplies of power consuming appliances such as computers, telecommunications apparatus such as transmitters, receivers, repeaters, base stations and smart phones, and battery chargers. A switching-mode power supply typically comprises an electronically switchable network having an output which is switchable between output states by operation of a power switching controller. The power switching controller (or switching controller in short) is usually configured to control or change operation parameters in order to modify or regulate electrical parameters of the output power, for example, according to output conditions. During operations, the switchable network is connected to a power source and electrical parameters of the output power available at the output of the switchable network are different to that of the power source as a result of modifications of power parameters due to switching operations upon passing through the switchable network.

Where a power switching controller is to facilitate control and regulation of a switching-mode power supply based on output power conditions, the detection of the output power conditions could be problematic where the output can vary within a wide range between a very high output condition corresponding to a maximum output condition and a very low output condition corresponding to a minimum output condition.

### OVERVIEW OF DISCLOSURE

There is also disclosed a switching mode power control device and a switching mode power supply (SMPS) comprising same. The switching mode power control device comprises switching control circuitry which is to generate switching control signals to facilitate switching operation of an electronically switchable network to perform power conversion, the switching control signals comprising alternating high-state and low-state pulses; wherein the electronically switchable network has a switchable conduction path and an output on the switchable conduction path, the output being switchable between a high output state to correspond to a higher voltage output and a low output state to correspond to a lower voltage output, and to switch alternately between the high output state and the low output state in response to application of the switching control signals; and wherein the switching control circuitry is to set the switching control signals to set or vary current output to a load during operation with reference to output voltage information (or output voltage waveform information) at the output of the switchable network.

The switching control circuitry utilises a current estimation scheme that can provide good estimation on the load current so that switching control signals can be set with reference to the estimated load current to operate an SMPS. This operation scheme is advantageous since load current can be estimated with a reasonable accuracy and lossy or resistive current sensing devices are not essential. The use of this non-loss or minimal loss current estimation scheme facilitates the detection of large current with low or minimal loss and detection of small current with reasonable accuracy without the use of highly resistant current sensors or other complicated current sensors.

The output voltage information may include total duration of the high output states during a detection time window, total duration of the low output states during a detection time window, and/or ratio between total duration of the high output states and total duration of the low output states during a detection time window. The output voltage information may include number of high output states within a detection time window, number of low output states within a detection time window, and/or ratio between number of low output states and number of high output states within a detection time window; and wherein the detection circuitry comprises state counting circuitry to count number of said high output states and/or said low output states. The output voltage information may include number of high output state pulses within a detection time window, number of low output state pulses within a detection time window, and/or ratio between number of high output state pulses and number of low output state pulses; and wherein the detection circuitry comprises pulse counting circuitry to count number of said high output state pulses and/or said low output state pulses.

Where the switchable conduction path is switchable between a conductive state and a non-conductive state, the output voltage information may include total duration of the conductive states within a detection time window, total duration of the non-conductive states within a detection time window, and/or ratio between the total duration of the conductive states and total duration of the non-conductive states within a detection time window.

There is also disclosed a method of setting output current of a switching mode power supply (SMPS). The method comprises using voltage information at an output node of a switchable network of the SMPS to estimate load current and to use the estimated load current to set output current.

### FIGURES

The disclosure will be described by way of example with reference to the accompanying Figures, in which:

FIG. 1 is a schematic diagram of an example SMPS according to the present disclosure,

FIG. 1A is a flow diagram depicting an example flow of operation of the SMPS of FIG. 1,

FIG. 1B is a flow diagram depicting an example flow of operation of the SMPS of FIG. 1 in an example operation mode,

FIG. 1C is a functional block diagram showing an example current estimation circuitry according to the disclosure,

FIG. 2 is a schematic diagram depicting an example SMPS according to the present disclosure,

FIG. 3 is a schematic diagram depicting an example SMPS according to the present disclosure,

FIGS. 4A and 4B are respectively schematic diagrams depicting example output voltage waveform and corresponding output current waveform in one operation mode (CCM mode),

FIGS. 5A and 5B are respectively schematic diagrams depicting example output voltage waveform and corresponding output current waveform in one operation mode (DCM mode),

FIGS. 6A and 6B are respectively schematic diagrams depicting example output voltage waveform and corresponding output current waveform in one operation mode (PSM mode),

FIG. 7 depicts an example power apparatus incorporating an SMPS according to the present disclosure and when in use,

FIGS. 8A and 8B are respectively schematic diagrams depicting example output voltage waveform and corresponding output current waveform of the power apparatus of FIG. 7 in one operation mode (CCM mode),

FIGS. 9A and 9B are respectively schematic diagrams depicting example output voltage waveform and corresponding output current waveform of the power apparatus of FIG. 7 in one operation mode (DCM mode), and

FIGS. 10A and 10B are respectively schematic diagrams of example output voltage and current waveforms of the power apparatus of FIG. 7 in one operation mode (PSM mode).

### DESCRIPTION

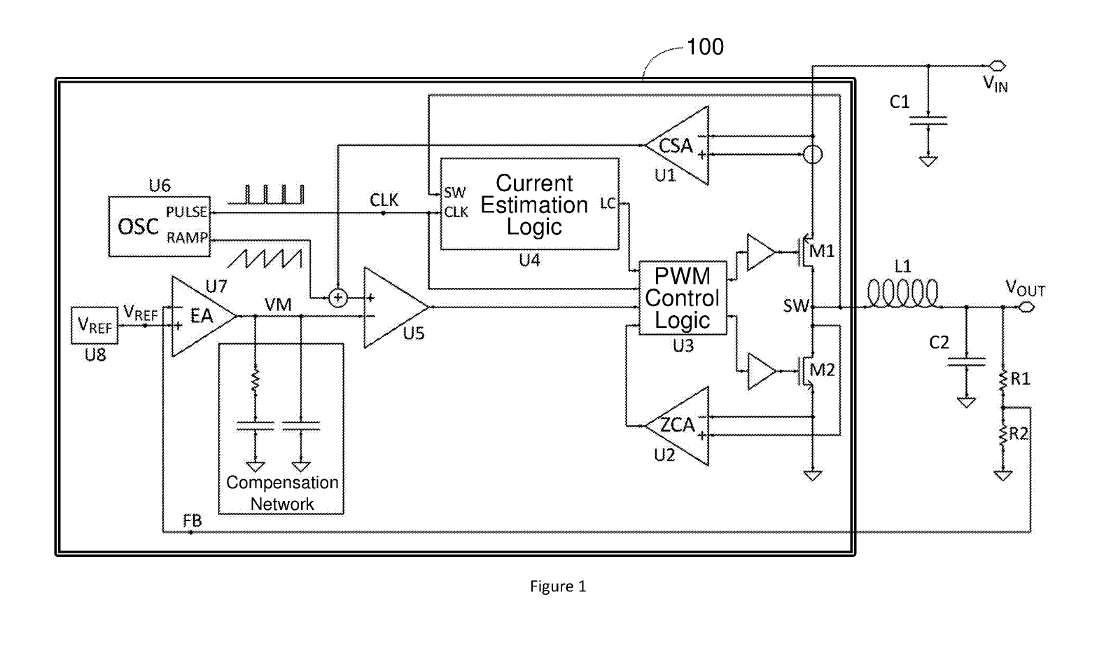

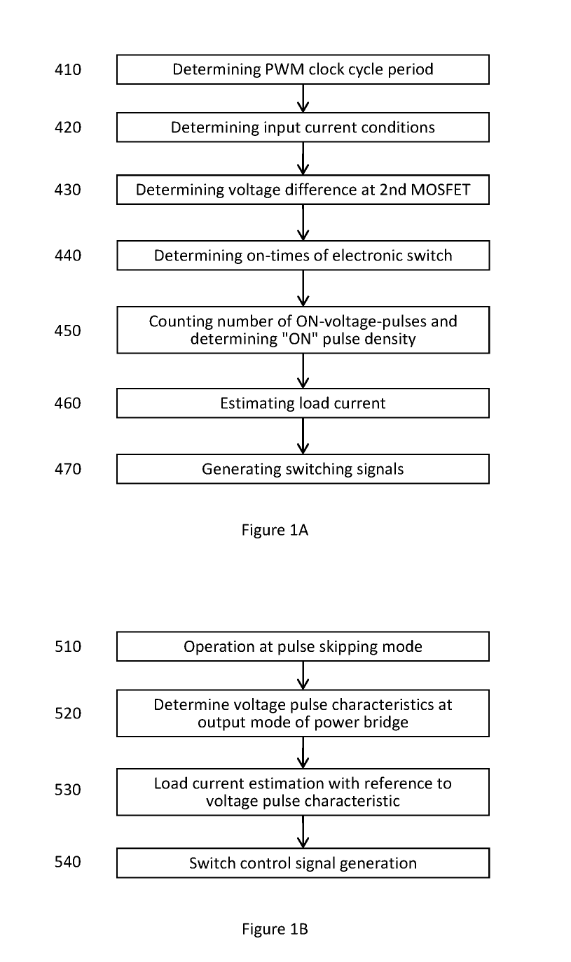

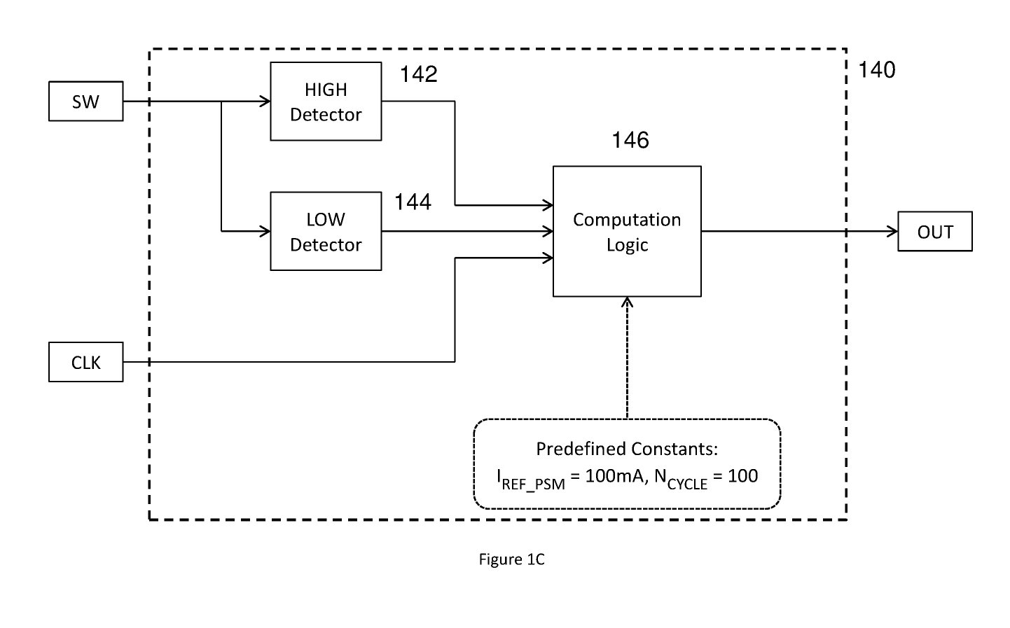

An example switching mode power supply (‘SMPS’) depicted in FIG. 1 comprises a switching controller 100 which is to operate to drive an example power conversion bridge to supply power to a load during operation when connected to a power supply V_{IN}. The example power conversion bridge is a 2-switch bridge comprising a first MOSFET M₁ and a second MOSFET M₂ in series connection and an output terminal SW at an interconnection node between the first M₁ and second M₂ MOSFETs. The first MOSFET M₁ has a switchable current conduction path which is defined between a first conduction terminal and a second conduction terminal. The second MOSFET M₂ has a switchable current conduction path which is formed between a first conduction terminal and a second conduction terminal. Each of the switchable current conduction paths of the first MOSFET M₁ and the second MOSFET M₂ is switchable between an ‘ON’ state and an ‘OFF’ state by applying a switching control signal at a third terminal which is a switching terminal or gate terminal. MOSFET M₁, M₂ are used as electronic switches in this power conversion bridge. When a MOSFET M₁, M₂ is switched to the ‘ON’ state (or turned on), the switchable current conduction path defined between the first and second conduction terminals is switched to the ‘ON’ state (or turned on) to provide a low impedance current conduction path. When a MOSFET M₁, M₂ is switched to the ‘OFF’ state (or turned off), the switchable current conduction path defined between the first and second conduction terminals is switched to the ‘OFF’ state (or turned off) to electrically isolate the first and second conduction terminals.

In the example of FIG. 1, M₁ is a P-MOSFET having its first terminal or source terminal connected to power supply V_{IN} and M₂ is an N-MOSFET having its second terminal or source terminal connected to reference ground. The second terminal or drain terminal of M₁ is connected to the first terminal or drain terminal of M₁ and this interconnection node is the output node SW of the power conversion bridge. MOSFETs are used as example electronic switches in the power conversion bridge to form an example electronically switchable network due to its low on-resistance during the ON state, its high impedance during the OFF state, and its high switching frequency characteristics.

The two control terminals of the power conversion bridge are connected to the output terminals of a switching control device U3 to facilitate alternative or complementary switching of MOSFETS M₁ and M₂. The switching control device U3 comprises a PWM control module. The PWM control module comprises a first output node which is connected to the gate terminal of M₁ via a first buffer which is an inverted buffer and a second output node which is connected to the gate terminal of M₂ via a second buffer. The control signals at the first and second output nodes of the switching control device U3 are to be logically complementary or opposite such that when the first output node is at logic high, the second output node is at logic low and vice versa. During power conversion operations, when M₁ is turned on and M₂ is turned off, the output terminal SW is pulled up to a high output voltage close to the supply voltage V_{IN}. Alternatively, when M₂ is turned on and M₁ is turned off, the output terminal SW is pulled down to a low output voltage close to the reference ground voltage. By repeatedly switching the power conversion bridge between the high output voltage state and the low output voltage state during an operation period, the power output of the SMPS, such as the voltage and/or current output can be varied by chopping. The switching frequency of an SMPS, as determined by the switching frequency F of the switching control device U3, is usually substantially higher than the mains power frequency of 50 or 60 Hz, for example, at above 10 kHz, although a lower switching frequency that is lower than the mains frequency can be used without loss of generality.

The switching controller 100 comprises an oscillator OSC module for generating system clock signals including clock pulses or timing pulses. The timing pulses are to facilitate generation of high frequency switching control signals to drive the first and second MOSFETs M₁, M₂. The oscillator module includes a first output PULSE to output pulses clock signings CLK and a second output RAMP for outputting ramp-shaped clock signals. The first output PULSE is connected to the switching control device U₃ and a current estimation device U₄.

The switching control device U3 is to control switching operation of the power conversion bridge M₁, M₂ to facilitate DC-DC conversion whereby a first voltage (or the input voltage) is converted into a second, different voltage during operation. In this example, the input voltage is DC (direct current), the voltage at output node SW is AC (alternating current) and alternating between Vᵢₙ and reference ground, and the output voltage (Vₒᵤₜ) of the SMPS at the output terminal of the SMPS terminal VOUT is DC. The example SMPS of FIG. 1 is a “Buck” converter to step down a higher input voltage (Vᵢₙ) to a lower output voltage (Vₒᵤₜ) for output at its output node SW.

The switching control device U3 has a first output terminal to send a first switching control signal to drive the control terminal of the first MOSFET M₁ and a second output terminal to send a second switching control signal to drive the control terminal of the second MOSFET M. The second switching control signal is always opposite or complementary to the first switching control signal so that the output at node SW of the power conversion bridge M₁, M₂ can alternately switch between ‘ON’ and ‘OFF’ states according to load requirements. The PWM control module comprises PWM control logic circuitry to control or vary pulse widths of the switching control signals to vary output power through pulse width modulation (PWM). The output terminals of the switching control device U3 are connected to the power conversion bridge via a pair of output buffers.

The switching control device U3 includes a plurality of input terminals to receive control parameters relating to output or load conditions of the SMPS to devise switching control signal generation. One of the control parameters is a load current parameter. The load current parameter is a parameter representing an estimated value of the instantaneous output current at the output node SW of the power conversion bridge M₁, M₂. The estimated value of the instantaneous output current is produced by operation of a current estimation module U4 through monitoring output voltage conditions at the output node SW of the power conversion bridge M₁, M₂. The switching control device U3 includes a clocking signal input terminal CLK which is connected to the PULSE terminal of the oscillator module OSC receive clocking signals therefrom. In operation, the switching control device U3 is to determine output or load conditions with reference to the load current parameter and to generate the switching control signals accordingly. The switching control device U3 may be a processor such as a micro-processor configured to generate switching control signals to operate the power conversion bridge as an example of an electronic switchable network to facilitate power conversion upon execution of instructions. During operation, the PWM control logic circuitry of the switching control device U3 is to generate switching control signal pulses at its outputs to repeatedly operate the first and the second MOSFETs M₁, M₂ in a complementary manner so that when one of the two MOSFETs M₁, M₂ is turned on, the other one will be turned off to facilitate a pulse-width modulated (PWM) output. The instantaneous switching pulses to be generated are determined and composed by the PWM control logic circuitry according to the instantaneous estimated load conditions through monitoring the output conditions at the output node SW. A load current sensing arrangement and a load voltage sensing arrangement are provided to facilitate monitoring of load conditions. The load voltage sensing arrangement includes a voltage divider which is connected to the output terminal Vout of inductor L1. This output terminal Vout is also the output terminal of the SMPS. The voltage divider is connected between output terminal Vout and the output ground and comprises a series connection of a first resistor R1 and a second resistor R2. Output voltage at the output node of the voltage divider is fed to voltage comparison circuitry comprising a reference voltage U8 and an error amplifier U7. Outcome of voltage comparison at the error amplifier U7 together with zero crossing information from U1 are fed to a comparator U5 and the outcome is sent to the PWM control logic circuitry U3 for setting the switching control signals.

The load current sensing arrangement comprises a voltage information or voltage waveform sensing node at terminal SW which is on the switchable conduction path defined by the first and the second MOSFETs. The voltage sensing node at the terminal SW voltage waveform information to facilitate non-lossy current estimation.

To facilitate zero crossing switching as a useful option, zero-crossing detection arrangement is provided as an option. The zero-crossing arrangement comprises an input current sensing arrangement and a voltage difference sensor. The input current sensing arrangement comprises a comparator U1 having its negative input node connected to the current input node of the first MOSFET switch and its positive input node connected to the output of a current sensor. The current sensor is arranged to detect current flow into the power conversion bridge via the first MOSFET switch and the output of the current sensor is in the form of voltage signals having a magnitude corresponding to the magnitude of the sensed current flow. The voltage difference sensor comprises a comparator U2 which is arranged to detect voltage difference across the drain and source terminals of the second MOSFET switch. The comparator U2 is connected such that its positive input terminal is connected to the higher potential side of the second MOSFET switch and its negative input terminal is connected to the lower potential side. Output of the comparator U2 is connected to an input terminal of the switching control device U3 which is shown as the fourth terminal on the left side of U3.

The voltage sensing node at the interconnection of the resistors R1 and R2 is connected to a negative input terminal of a voltage comparator U7, and the positive input terminal of the voltage comparator U7 is connected to a reference voltage Vref. The comparator output of U7 is connected to the negative input terminal of another comparator U5 and the positive input terminal of the comparator U5 is connected to a summed input of the RAMP output and output of the comparator U1. Output of the comparator U5 is connected to an input terminal of the switching control device U3. That input terminal is shown as the third terminal on the left side of U3.

Clock signals are provided to the switching control device U3 by connecting the CLK output of the oscillator to an input terminal of the switching control device U3. That input terminal is shown as the second terminal on the left side of U3. Output of a current estimation circuitry U4 is connected to an input terminal of the switching control device U3. That input terminal is shown as the first terminal on the left side of U3. The first, second, third and fourth input terminals of the switching control device U3 are separate inputs isolated from each other.

The current estimation circuitry comprises arrangements to determine load or output current with reference to the voltage conditions appearing at the terminal SW. In an example, the load or output current is estimated with reference to the number of high voltage pulses or low voltage pulses. Such a current estimation methodology mitigates the need of a serially connected current sensing resistor and at the same times provides a reasonably accurate estimation of a relatively small load current.

The switching control device U3 is arranged to control operation of the SMPS in two modes, namely, continuous-conduction-mode (CCM) and discontinuous-conduction-mode (DCM), with reference to loading conditions. Continuous-conduction-mode (CCM) is so-named because the current in the energy transfer inductor never goes to zero in each switching cycle. In discontinuous-conduction-mode (DCM) the current goes to zero during part of the switching cycle.

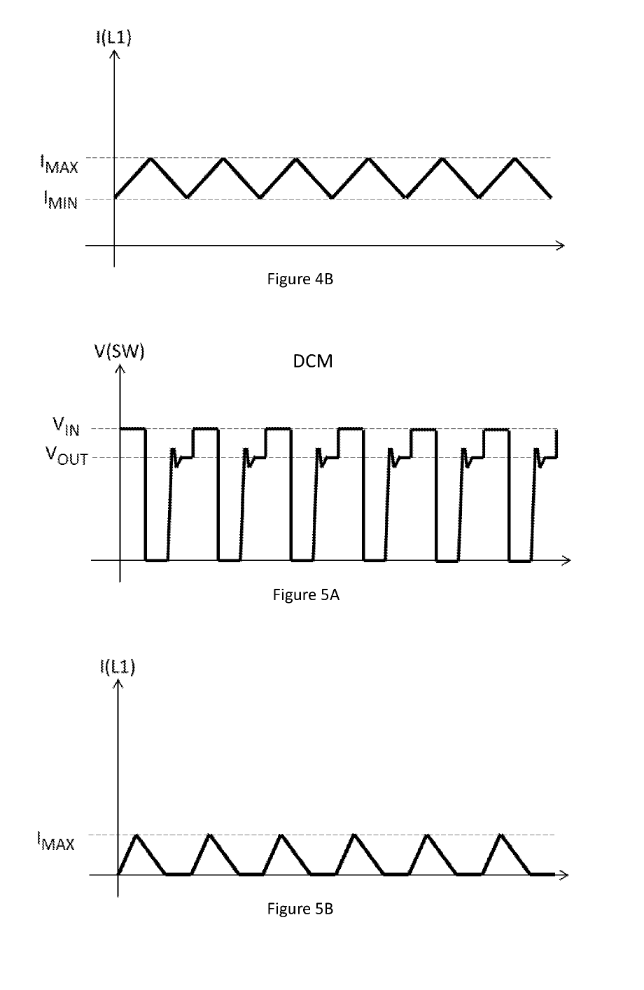

When the SMPS is set into initial operation, the SMPS will usually be at a continuous conduction mode (CCM). When in CCM, the first and second MOSFETS are alternately switched on and off at regular intervals and the voltage at the terminal SW will be alternately switched between the first voltage and the second at that regular interval as depicted in FIG. 4A. In this CCM mode, current always flows through the output inductor L1 and the current pulses are at regular intervals following or dependent on the CLK period or switching cycles. As depicted in the current waveform of FIG. 4B, each current pulse is has a triangular shape.

When the loading conditions at the load is such that a lower load current than the CCM current is required, for example as indicated by a rise in the load voltage to a predetermined threshold, the switching control device U3 will change the mode of operation into the DCM. When in DCM, a voltage pulse during a switching cycle changes between the first voltage Vᵢₙ, the second voltage ground (0V) and the instantaneous load voltage Vₒᵤₜ and current only flows through the output inductor L1 for a portion of the time but the current pulses are still at regular intervals following or dependent on the CLK period. In the example DCM voltage waveform as depicted in FIG. 5A, there is an ON pulse during each switching cycle and the ON pulses are identical. However, each “ON” pulse does not have a constant peak voltage level Vᵢₙ, but includes a first portion at Vᵢₙ, second portion at the reference ground and a third portion at Vₒᵤₜ. The relative duration of the first and second portions may vary to change the output current. In PWM (pulse width modulation) terms, the relative duration is known as a duty ratio and a clock cycle is referred to as a PWM cycle. As depicted in FIG. 5B, there is a current pulse during each switching cycle and the current pulses are identical. However, each of the current pulse does not extend for the full switching cycle but only part of the switching cycle.

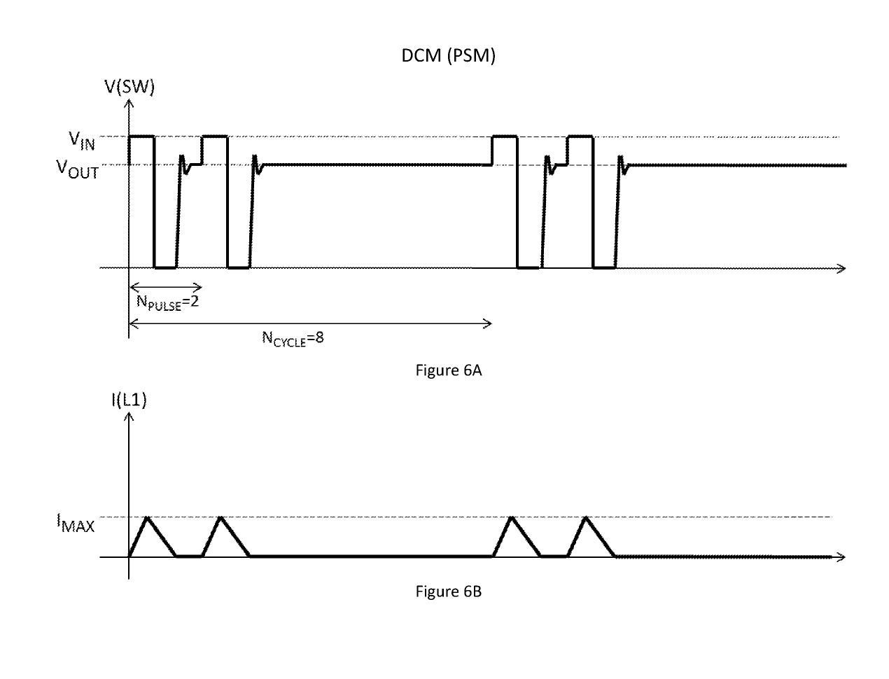

When the loading conditions at the load is such that a still lower load current than the minimum available DCM current is required, for example as indicated by a further rise in the load voltage to another higher predetermined threshold, the switching control device U3 will change the mode of operation into a pulse skipping mode (PSM). PSM, also known as pulse frequency mode (PFM), is a particular case of DCM. When in the PSM, a voltage pulse during an ON period of the first MOSFET switch only has a voltage reaching the first voltage during some but not all clock periods and the load voltage Vₒᵤₜ current flows through the output inductor L1 only for some but not all clock periods. In the example DCM voltage waveform as depicted in FIG. 6A, there are intermittent ON voltage pulses during some but not all switching cycles. The shape of each ON pulse is similar or substantially identical to that of FIG. 5A. Likewise, each “ON” pulse does not have a constant peak voltage level Vᵢₙ, but includes a first portion at Vᵢₙ, a second portion at the reference ground (0V) and a third portion at Vₒᵤₜ and the relative duration of the first and second portions is variable to change current output. As depicted in FIG. 6B, currents pulses only occur at intermittent switching cycles but not all switching cycles. The intermittent current pulses correspond to the intermittent “ON” voltage pulses and the current pulses are identical. However, each of the current pulse does not extend for the full switching cycle but only part of a switching cycle.

Therefore, a DC-DC converter with synchronous rectifier has been described. The DC-DC converter operates in the CCM mode when the load current is high and a switching control device will change the DC-DC converter operation from the CCM to the DCM when the load current requirement becomes low. The switching control device will further change operation from the DCM to the special case of PSM by skipping some pulses when the load current further decreases.

An ideal DC-DC converter does not need to skip pulses in DCM since its pulse width can be ideally reduced to zero or close to zero. However, a DC-DC converter in practical implementations has a minimum turn on time and a finite response delay and other adverse non-ideal factors. As a result, a DC-DC converter needs to skip pulses in order to output a load current below that can be supplied by non-pulse-skipping DCM operations.

As the load or output currents of this DC-DC converter will change substantially from the CCM to the DCM and the PSM, current measurements through detecting voltage drop across a current sensing resistor can be problematic.

In the example DC-DC converter, the load or output current is determined with reference to the voltage at the terminal SW. For example, the load or output current is estimated by determining the density of “ON” pulses during a selected window period. The density of “ON” pulses means the average number of “ON” pulses per clock cycle and this is equal to the number of “ON” pulses (N_{PULSE}) during a period divided by the number of clock cycles (N_{CYCLE}) during that period. The density is 1 for CCM and DCM but is less than 1 for the PSM.

As an example, the load current during the PSM can be estimated as follows:

$${I}_{OUTPUT} \approx {I}_{Ref \_ PSM} \times \frac{{N}_{PULSE}}{{N}_{CYCLE}}$$

Where I_{Ref}_{_}_{PSM} is a reference average load current corresponding to a current when the “ON” pulse density equals 1. This reference load current can be pre-determined with reference to the peak load current I_{MAX}, on-time of the first MOSFET, on-time of the second MOSFET, duration of each switching clock cycle, and taking into account other factors or errors.

In the DC-DC converter, the current estimation circuitry U4 is to count the number of “ON” pulses (N_{PULSE}) and the number of clock cycles (N_{CYCLE}) during that period to determine the “ON” pulse density and load current. The comparator U₂ is configured as a ZCA (zero-crossing amplifier) to detect zero current and gives a zero-current signal when zero-current is detected. A zero-current signal would signify operation of the DC-DC converter in the DCM. By utilizing the clocking signals CLK, the switching signals SW, and the zero current signals, the “ON” pulse density can be determined and the load current can be estimated.

A functional block diagram of an example current estimation circuitry 140 depicted in FIG. 1C comprises a high detector 142, a low detector 144 and computational logic circuitry 146. The high detector 142 is a comparator for determining whether the voltage at its input has risen to a predetermined high voltage. The low detector 144 is a comparator for determining whether the voltage at its input has fallen to a predetermined low voltage. The input of the high detector 142 is connected to a first input node of the computational logic circuitry 146 and the input of the low detector 144 to a second input node of the computational logic circuitry 146. The clocking signals CLK is connected to a third input node of the computational logic circuitry 146. Predefined constants including the value of the reference average load current (I_{Ref}_{_}_{PSM}) and the number of PWM clock cycles (N_{CYCLE}) for a reference detection window can be set into the computational logic circuitry 146.

During operations, the high detector 142 will determine whether the switching node SW has reached the first higher voltage V_{IN} and will give a “High” logic output if the first higher voltage is detected. The low detector 144 will determine whether the voltage at the switching node SW has reached the second lower voltage (reference ground) and will give a “Low” logic output if the second higher voltage is detected. If a “High” output from the high detector or a “Low” output from the low detector is not detected at the corresponding input nodes of the computational logic circuitry 146, the computational logic circuitry 146 will interpret that as corresponding to a condition when the SW node is pulled to the output voltage of V_{OUT} of the output inductor (e.g., L1 of FIG. 1), and this condition will be interpreted as a pulse skipping condition (“PSC”). It will be noted that the inductor current is zero when the switching node is pulled to V_{OUT}, and the duration of non-zero current duration will be the time when the switching node SW is pulled to either HIGH or LOW.

When occurrence of this PSC is detected by the computational logic circuitry 146, the computation logic of the computational logic circuitry 146 will operate to count the number of pulses N_{PULSE} during each reference detection window period of N_{CYCLE} cycles. The computational logic circuitry 146 can then estimate the load current using the preset or predefined constants of the reference current value (I_{Ref}_{_}_{PSM}) and reference PWM counts (N_{CYCLE}) as follows:

$${I}_{OUTPUT} \approx {I}_{Ref \_ PSM} \times \frac{{N}_{PULSE}}{{N}_{CYCLE}}$$

In the example of FIGS. 6A and 6B, the are two pulses in each sampling window of eight cycles and the reference average current I_{Ref}_{_}_{PSM} is 100 mA, giving an estimated load current I_{OUTPUT} of:

$${I}_{OUTPUT} \approx 100 mA \times \frac{2}{8} = 25 mA$$

The switching controller can then use the estimated load current to facilitate operation of the power conversion bridge to meet different loading current requirements.

### Current Mode PWM Converter

The DC-DC converter of FIG. 1 is a current mode PWM DC-DC converter. In a current mode PWM DC-DC converter, the modulation voltage corresponds to the inductor current. The maximum inductor current I_{MAX} at PSM can be estimated with reference to the minimum modulation voltage and response delay of the DC-DC converter. Logic circuitry is added to count the number of pulse (N_{PULSE}) in each sampling period (N_{CYCLE}) and to detect the total duration of output conduction time (t_{ON}_{_}_{HS}+t_{ON}_{_}_{LS}) in each cycle. The total load current I_{OUTPUT} can be estimated as follow:

For a current mode buck converter,

$${I}_{OUTPUT} \approx \frac{1}{2} {I}_{MAX} \times \frac{{t}_{ON \_ HS} + {t}_{ON \_ LS}}{{t}_{CYCLE}} \times \frac{{N}_{PULSE}}{{N}_{CYCLE}}$$

For a current mode boost converter,

$${I}_{OUTPUT} \approx \frac{1}{2} {I}_{MAX} \times \frac{{t}_{ON \_ HS}}{{t}_{CYCLE}} \times \frac{{N}_{PULSE}}{{N}_{CYCLE}}$$

### Voltage Mode PWM Converter

While the above description has been made with reference to a current mode DC-DC converter, the present disclosure is equally applicable to a voltage mode DC-DC converter with the following adaptation.

In a voltage mode PWM DC-DC converter, the modulation voltage has no direct relation with the maximum inductor current. The maximum inductor current I_{MAX} has to be estimated from the minimum turn on time of the converter t_{MIN} (t_{ON}_{_}_{LS}), the input voltage V_{IN}, the output voltage V_{OUT} and the inductance of the inductor L. The peak current I_{MAX} of the inductor can be estimated as follow:

For a voltage mode buck converter,

$${I}_{MAX} = \frac{{V}_{IN} - {V}_{OUT}}{L} \times {t}_{MIN}$$

For a voltage mode boost converter,

$${I}_{MAX} = \frac{{V}_{IN}}{L} \times {t}_{MIN}$$

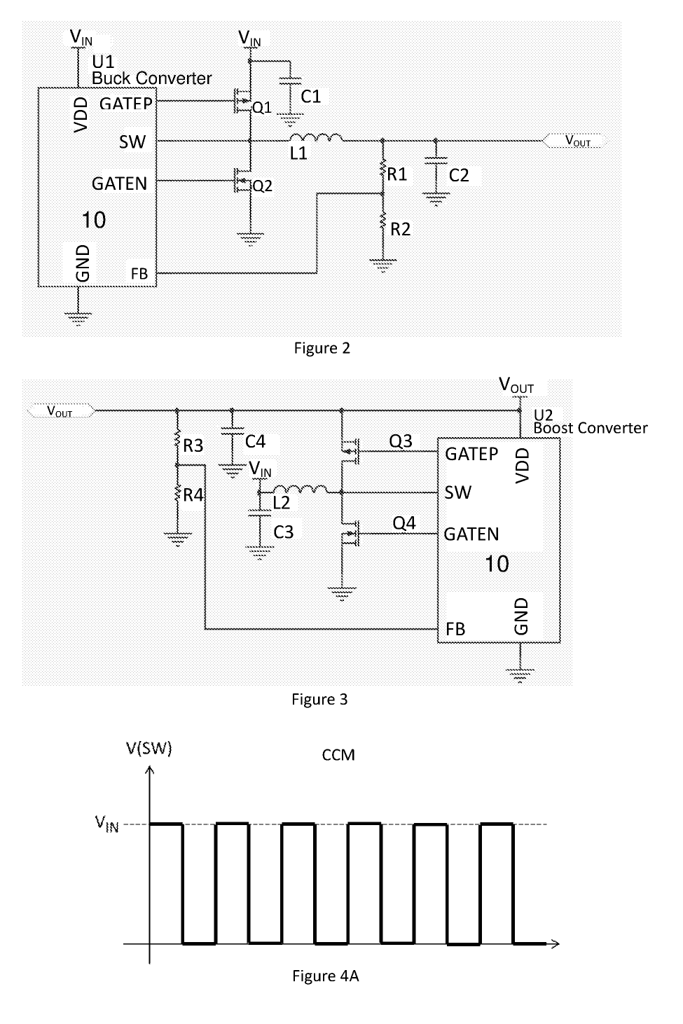

In the example DC-DC converter of FIG. 2, the power switching controller is the same as that of power switching controller 100 and is in the form of an IC (integrated circuit) excluding the power conversion bridge and zero current detection. The power conversion bridge, in particular the first MOSFET Switch Q1 and the second MOSFET Switch Q2, is outside the IC 10. The IC 10 includes a first switching node GATEP to connect to the gate control terminal of MOSFET Q1, a second switching node GATEN to connect to the gate control terminal of MOSFET Q2, a switching signal detection terminal SW to connect to the interconnection of the first and second MOSFET switches, a supply terminal VDD to connect to a supply or source voltage, a ground terminal GND to connect to a reference ground, a voltage feedback terminal FB to connect to a load voltage sensing bridge R1+R2. The SW terminal is to connect to a load via a serial inductor L1.

In the example DC-DC converter of FIG. 3, the power switching controller is configured to form a boost converter. In this arrangement, the SW terminal is to connect to a supply voltage Vin via a serial inductor L1, the VDD terminal is an output terminal to connect to a load, and voltage feedback terminal FB to connect to a load voltage sensing bridge R1+R2. In this example boost converter, the operation and current estimation methodology are substantially the same, although Vin and Vout of FIGS. 4A, 5A and 6A are to be interchanged without loss of generality.

During example operations, the mode of operation of the DC-DC converter will be determined by the current estimation circuitry U4. If the DC-DC converter is in the PSM, the pulse density will be counted and the load current will be computed accordingly. The estimation logic will check the node SW to see if there is any pulse skipped in the switching cycles. If there is, it is in PSM and the estimation logic can count the pulse density. If not, the estimation logic simply reports the load current is not low. Once the pulse density (10 pulses in 100 switching cycles, say) is counted, the estimation logic use the predefined current reference I_{REF}_{_}_{PSM} (100 mA, say) to compute the load current.

Therefore, there is disclosed a method of determining load current output of a switching mode power supply at pulse skipping mode operation. The switching mode power supply comprising a power conversion bridge having at least a first electronic switch which is to operate to switch an input voltage to as either an ON-voltage-pulse or an OFF-voltage-pulse at an output terminal of said first electronic switch. referring to FIG. 1B, the method comprises operating a switch mode power supply at pulse skipping mode 510, determining voltage pulses characteristics of at said output terminal at 520, estimating load current with reference to voltage pulses characteristics at 530, and generating switching control signals at 540.

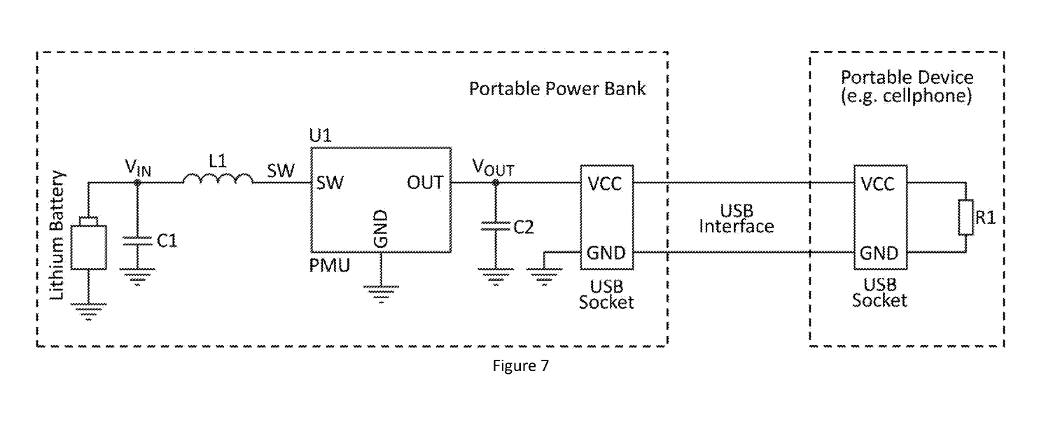

An example power apparatus depicted in FIG. 7 comprises a switching mode power supply (SMPS) as a power converter which is connected to a lithium battery as a power source to operate as a power bank. A ‘power bank’ is a common name of a portable charging device having a built-in power source which is commonly used to provide mobile charging to the battery of a cell phone. A typical power bank has an output voltage output of 5V to charge a lithium battery having a rated voltage of around 3.6-3.7V. The SMPS of the power bank is a ‘boost’ converter as the SMPS is to provide a charging voltage of about 5V from a source voltage of 3.6-3.7V. In the example SMPS of FIG. 7, the power conversion bridge M1, M2 and the switching control circuitry 100 are formed as a single integrated circuit (U1, PMU). The positive terminal of the power bank battery is connected to the SW node of the power conversion bridge via inductor L1. The output terminal OUT of the power bank is the VIN terminal equivalent of FIG. 1 in this boosting configuration and the output terminal OUT is connected to a USB output socket for electrical and mechanical coupling with a corresponding USB socket on the cell phone.

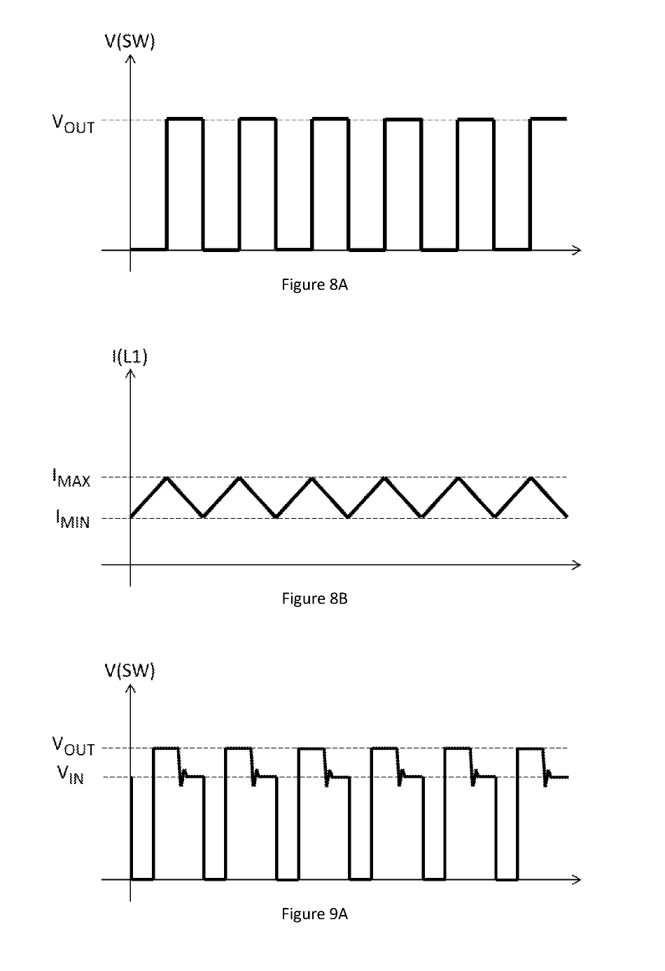

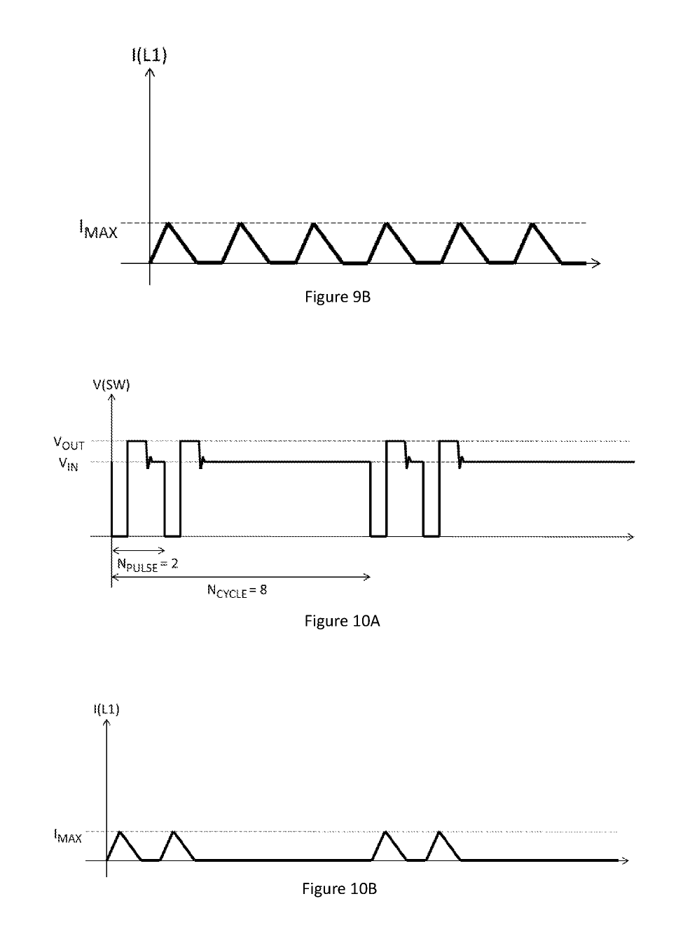

When a cell-phone (or other load) in low-battery condition is connected to the power bank, the power conversion circuitry will start switching and a charging voltage will be available at the USB output socket. If the cell-phone is in active mode to allow external charging of its internal battery, a large amount of current (say, 1 A to 2 A) will be drawn from the power bank and the SMPS will operate in CCM of FIGS. 8A and 8B. When the voltage of the cell-phone battery rises to near its fully charged voltage, a smaller amount of current (say, about 100 mA) will be drawn from the power bank, and the SMPS will operate in DCM of FIGS. 9A and 9B. When the cell-phone battery is fully charged, the cell-phone will go to a deep sleep mode and draw a very small amount of current (less than 20 mA) from the power bank and the SMPS will operate in PSM of FIGS. 10A and 10B. In the various modes of operation the current estimation schemes are used to set the switching control signals to operate the SMPS.

While a power bank has been used as an example herein, it should be appreciated that application and operations of the SMPS shall apply mutatis mutandis without loss of generality. While the disclosure has been described herein with reference to examples, the examples are not intended and should not be used to limit the scope of disclosure.

1-18. (canceled)

19. A switching mode power control device comprising switching control circuitry which is to generate switching control signals to facilitate switching operations of an electronically switchable network to perform power conversion, the switching control signals comprising alternating high-state and low-state pulses; wherein the electronically switchable network has a switchable conduction path and an output on the switchable conduction path, the output being switchable between a high output state to correspond to a higher voltage output and a low output state to correspond to a lower voltage output, and to switch alternately between the high output state and the low output state in response to application of the switching control signals; wherein the switchable conduction path is defined between two conduction terminals of an electronic switch and the output is one of the two conduction terminals of the electronic switch which is switchable between the high output state and the low output state; and wherein the switching control circuitry is to set the switching control signals to set or vary current output to a load during operation with reference to output voltage information at the output of the switchable network.

20. The switching mode power control device according to claim 19, wherein the switching control circuitry comprises current estimation circuitry to estimate load current or output current at the output using said output voltage information.

21. The switching mode power control device according to claim 19, wherein the switching control circuitry comprises detection circuitry to obtain the output voltage information and to estimate load current or output current using said output voltage information.

22. The switching mode power control device according to claim 19, wherein the output voltage information includes total duration of the high output states during a detection time window, total duration of the low output states during a detection time window, and/or ratio between total duration of the high output states and total duration of the low output states during a detection time window.

23. The switching mode power control device according to claim 19, wherein the switchable conduction path is switchable between a conductive state and a non-conductive state, and the output voltage information includes total duration of the conductive states within a detection time window, total duration of the non-conductive states within a detection time window, and/or ratio between the total duration of the conductive states and total duration of the non-conductive states within a detection time window.

24. The switching mode power control device according to claim 21, wherein the output voltage information includes number of high output states within a detection time window, number of low output states within a detection time window, and/or ratio between number of low output states and number of high output states within a detection time window; and wherein the detection circuitry comprises state counting circuitry to count number of said high output states and/or said low output states.

25. The switching mode power control device according to claim 21, wherein the output voltage information includes number of high output state pulses within a detection time window, number of low output state pulses within a detection time window, and/or ratio between number of high output state pulses and number of low output state pulses; and wherein the detection circuitry comprises pulse counting circuitry to count number of said high output state pulses and/or said low output state pulses.

26. The switching mode power control device according to claim 20, wherein the control circuitry comprises an oscillator to generate timing or clock signals and the current estimation circuitry or detection circuitry uses said timing or clock signals to determine the output voltage information and/or to estimate load current.

27. The switching mode power control device according to claim 19, wherein the switching control circuitry is to estimate the load current or output current with reference to a pre-set reference current or a pre-set maximum output current and the output voltage information.

28. The switching mode power control device according to claim 19, wherein the switching control circuitry is to determine said output voltage information with reference to voltage duty cycle at said output.

29. A switching mode power supply comprising a power conversion bridge and a switching mode power control device; wherein the power conversion bridge comprises an electronically switchable network, the electronically switchable network comprising an electronic switch having an output which is switchable between a high output state to correspond to a higher voltage output and a low output state to correspond to a lower voltage output and to switch alternately between the high output state and the low output state in response to application of the switching control signals to facilitate power conversion during power conversion operations; wherein the switching mode power control device comprises switching control circuitry for generating switching control signals to facilitate switching operations of the power conversion bridge, the switching control signals comprising alternating high-state and low-state pulses; and wherein the switching control circuitry is to set the switching control signals to set or vary current output to a load during operation with reference to output voltage information at the output of the switchable network; and wherein an inductor is provided at the output to connect the output to a load and to facilitate delivery of load current to the load.

30. A switching mode power supply according to claim 29, wherein a voltage sensing device is provided at an output end of the inductor to provide load voltage information to the switching control circuitry, and the switching control circuitry is to set the switching control signals to adjust output voltage according to the load voltage information.

31. The switching mode power supply according to claim 29, wherein the power conversion bridge comprises a first electronic switch and a second electronic switch in series connection and defining a switchable conduction path, the output being on the switchable conduction path; wherein the first electronic switch has a first control terminal and the second electronic switch has a second control terminal, and the switching mode power control device is to send complementary or opposite switching control signals to the first and second control terminals to drive the power conversion bridge alternately switchable between the high and low output states; and wherein the switching control circuitry is to set the switching control signals to vary current output to a load during operation with reference to output voltage information at the output of the switchable network.

32. The switching mode power supply according to claim 29, wherein the switching control circuitry comprises current estimation circuitry to estimate load current or output current at the output using said output voltage information.

33. The switching mode power supply according to claim 29, wherein the switching control circuitry comprises detection circuitry to obtain the output voltage information and to estimate load current or output current using said output voltage information.

34. The switching mode power supply according to claim 29, wherein the output voltage information includes total duration of the high output states during a detection time window, total duration of the low output states during a detection time window, and/or ratio between total duration of the high output states and total duration of the low output states during a detection time window.

35. The switching mode power supply according to claim 29, wherein the power conversion bridge and the switching mode power control device are integrally formed on a single semiconductor as an integrated circuit.

36. A method of operating a switching mode power supply having a power conversion bridge, the power conversion bridge comprising an electronically switchable network which includes at least one electronic switch which has an output terminal switchable between a high output state to correspond to a higher voltage output and a low output state to correspond to a lower voltage output and to switch alternately between the high output state and the low output state in response to application of the switching control signals to facilitate power conversion during power conversion operations; wherein the method comprises devising switching control signals to operate the power conversion bridge using output voltage information obtained at the output terminal of the power conversion bridge and to set output current.

37. The method according to claim 36, wherein the electronic switch is to operate to switch an input voltage to as either an ON-voltage-pulse or an OFF-voltage-pulse at the output terminal of said electronic switch, and the method comprises determining load or output current of the power bridge during pulse skipping mode operation and/or controlling current output with reference to characteristics of voltage pulses or voltage waveform at said output terminal.

38. The method according to claim 37, wherein the characteristics of voltage pulses at said output terminal include one of the following a) relative occurrence frequency of said ON-voltage-pulses and said an OFF-voltage-pulses, b) the relative duration of said ON-voltage-pulses and said OFF-voltage-pulses during a detection window period of a number of clock cycles (N_{CYCLE}), number of said ON-voltage-pulses (N_{PULSE}_{_}_{ON}) and/or c) number of said OFF-voltage-pulses (N_{PULSE}_{_}_{OFF}) within a detection window of a number of clock cycles (N_{CYCLE}).
